(19) United States
(12) Patent Application Publication
(10) Pub. No.: US 2005/0258553 A1
(43) Pub. Date: Nov. 24, 2005

(54) Method for the organometallic production of organic intermediate products comprising carbon-heteroatom bonds achieved by the deprotonation of heteroatoms

(76) Inventors: Andreas Meudt, Hofheim (DE); Bernd Lehnemann, Frankfurt am Main (DE); Michael Erbes, Frankfurt am Main (DE); Klaus Forstinger, Babenhausen (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/526,327

(22) PCT Filed: Aug. 21, 2003
(86) PCT No.: PCT/EP03/09250

§ 371 Date: Feb. 28, 2005

(30) Foreign Application Priority Data
Aug. 31, 2002 (DE) 102 40 260.4

(51) Int. Cl. C07F 9/02; C07F 1/02

(52) U.S. Cl. 260/665 R; 564/250; 558/342; 568/7; 568/449; 564/124

(57) ABSTRACT

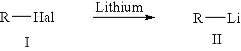

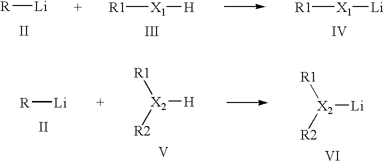

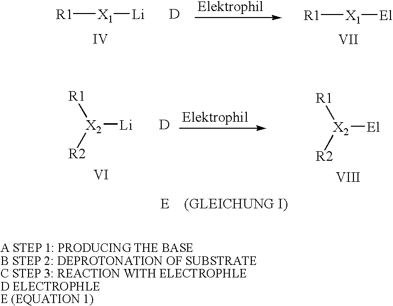

The invention relates to a method for binding heteroatom-carbon bonds. According to said method, a lithium compound (II) is first generated by reacting aliphatic or aromatic halogen compounds (I) with lithium metal, said compound is then used for the deprotonation of the compounds (III) or (V). The lithium salts of formulas (IV) or (VI) obtained by said deprotonation are subsequently reacted with suitable carbon electrophiles (equation I), said process binding the heteroatom-carbon bond and forming the products (VIII) or (VIII), (equation I).

The invention relates to a process for preparing organic compounds having carbon-heteroatom bonds, in which aliphatic or aromatic halogen compounds (I) are firstly reacted with lithium metal to generate a lithium compound (II) which is then used to deprotonate the compounds (III) or (V), and the resulting lithium salts of the formula (IV) or (VI) are subsequently reacted with suitable carbon electrophiles to form the heteroatom-carbon bond and produce the products (VIII) or (VIII) (EQUATION 1).
Step 1: Generation of the base 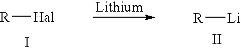
Step 2: Deprotonation of the substrate 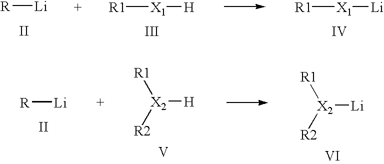
Step 3: Reaction with an electrophile

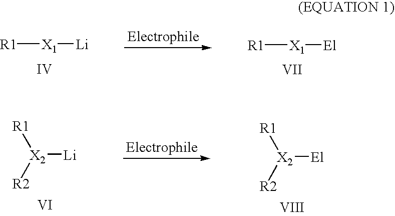

The upswing in organometallic chemistry, in particular that of the element lithium, in the preparation of compounds for the pharmaceutical and agrochemicals industries and also for numerous further applications has progressed almost exponentially in the past few years if the number of applications or the quantity of products produced in this way is plotted against a time axis. Significant reasons for this are, firstly, the evermore complex structures of the fine chemicals required for the pharmaceuticals and agrochemicals sectors and, secondly, the virtually unlimited synthetic potential of organolithium compounds for building up complex organic structures.

A large part of this development has involved the use of organolithium compounds and alkali metal hydrides as strong bases having a low nucleophilicity for the deprotonation of alcohols, phenols, thiols, amines, etc., i.e. the generation of heteroatom anions, for reaction with electrophiles.

The major part of this chemistry requires the use of commercial alkyllithium or aryllithium compounds, with n-butyllithium, methyllithium or phenyllithium most commonly being used here. The synthesis of such lithioaromatics and lithioaliphatics is technically complicated and requires a great deal of know-how, as a result of which methyllithium, n-butyllithium, s-butyllithium, tert-butyllithium, phenyllithium and similar molecules are, from an industrial viewpoint, offered at very high prices. This is the most important but far from the only disadvantage of these otherwise very advantageous and widely usable strong bases. Although alkali metal hydrides are cheaper, they have, owing to their considerably lower basisity, the disadvantage of a considerably smaller range of applications.

Owing to the extreme sensitivity and, in concentrated solutions, pyrophoric nature of organolithium compounds, very costly logistics systems for transport, introduction into the metering reservoir and metering are required for the large amounts (annular production quantities of from 5 to 500 metric tons) wanted in large-scale industrial production. A similar situation applies to the alkali metal hydrides which are likewise pyrophoric in pure form and are frequently stabilized with mineral oil. The processing of these solids which have a very poor solubility in organic solvents under the relevant conditions is a problem which has not really been solved in industry.

Furthermore, the deprotonation of H-acidic compounds by means of methyllithium forms methane gas and the use of n-, s- and tert-butyllithium forms butanes which are likewise gaseous at room temperature and are given off during the reaction or in the necessary hydrolytic work-ups of the reaction mixture. As a result, complicated offgas purifications or appropriate incineration facilities are also necessary in order to meet strict pollution laws. As a way of avoiding this, specialist companies are offering alternatives such as n-hexyllithium which do not result in formation of butanes, but are significantly more expensive than butyllithium. The use of phenyllithium, on the other hand, leads to formation of the human carcinogen benzene, which frequently rules out industrial use. Alternatives such as 4-tolyllithium are very difficult to obtain on the market, especially not in the volume required for production tasks.

Even greater difficulties than those posed by the lower alkyllithium compounds are presented by the use of alkali metal hydrides, since their use results in the formation of hydrogen which, particularly at high temperatures, can lead not only to exhaust air problems (danger of formation of explosive hydrogen/oxygen mixtures) but also to damage to materials, e.g. embrittlement of metals caused by diffusion and incorporation.

A further disadvantage is that complex solvent mixtures are obtained after the work-up. Owing to the high reactivity of organolithium compounds toward ethers, which are virtually always used as solvents for the subsequent reactions, alkyllithium compounds can usually not be marketed in these solvents. Producers do offer a broad range of alkyllithium compounds in a wide variety of concentrations in a wide variety of hydrocarbons and ether/hydrocarbon mixtures, but hydrolysis results in water-containing mixtures of ethers and hydrocarbons whose separation is complicated and can in many cases not be carried out economically at all. This likewise applies to the mineral oil in which the alkali metal hydrides are usually supplied. However, recycling of the solvents used is an indispensable prerequisite for large-scale industrial production.

For the reasons mentioned, it would therefore be very desirable to have a process in which an alkyllithium compound to be used for deprotonation, which as far as possible overcomes the disadvantages mentioned, is generated from the cheap raw materials haloalkane or haloaromatic and lithium metal in an ether and reacted simultaneously or subsequently with the substrate to be deprotonated, since this procedure can overcome all the abovementioned disadvantages of the “classical” generation of the lithium compounds mentioned.

The present invention achieves all these objects and provides a process for forming heteroatom-carbon bonds, in which aliphatic or aromatic halogen compounds (I) are firstly reacted with lithium metal to generate a lithium compound (II), this is then used for deprotonating the compounds (III) of (V), and the resulting lithium salts of the formula (IV) or (VI) are finally reacted with suitable carbon electrophiles to form the heteroatom-carbon bond and produce the product (VIII) or (VIII) (equation I).
Step 1: Generation of the base 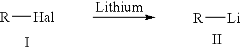
Step 2: Deprotonation of the substrate 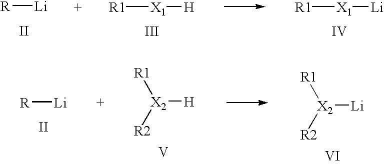
Step 3: Reaction with an electrophile

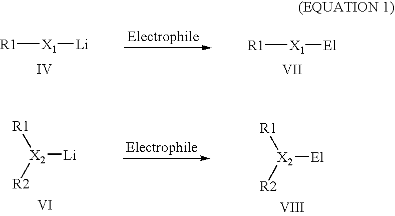

Here, R is methyl, a primary, secondary or tertiary branched or unbranched alkyl radical having from 1 to 20 carbon atoms, a phenyl, aryl or heteroaryl radical, alkyl substituted by a radical from the group consisting of {methyl, primary, secondary or tertiary alkyl, phenyl, substituted phenyl, aryl, heteroaryl, alkoxy, dialkylamino, alkylthio}, substituted or unsubstituted cycloalkyl having from 3 to 8 carbon atoms,
Hal=fluorine, chlorine, bromine or iodine,
X₁ is an oxygen or sulfur bound via a single bond to R1 or an sp2-hybridized nitrogen bound via a double bond to R1, and X₂ is an sp3-hybridized nitrogen, the radicals R₁ and R₂ are each, independently of one another, a substituent selected from the group consisting of {hydrogen, methyl, primary, secondary or tertiary, cyclic or acyclic alkyl, alkenyl or alkynyl radicals having from 1 to 20 carbon atoms, substituted cyclic or acyclic alkyl groups, acyl groups, alkoxy, aryloxy, dialkylamino, alkylamino, arylamino, diarylamino, alkylarylamino, imino, sulfone, sulfonyl, phenyl, substituted phenyl, alkylthio, diarylphosphino, dialkylphosphino, alkylaryl-phosphino, dialkylaminocarbonyl or diarylaminocarbonyl, monoalkylamino-carbonyl or monoarylaminocarbonyl, alkylarylaminocarbonyl, alkoxyalkyl, carboxylate, alkylcarboxylate, CN or CHO, heteroaryl}, where two adjacent radicals R₁ and R₂ can together correspond to an aromatic or aliphatic ring.

Preferred compounds of the formula (III) which can be reacted by the process of the invention are, for example, alcohols, thiols, phenols, thiophenols, oximes, hydrazones, and preferred compounds of the formula (V) are, for example, amines, carboxamides, sulfonamides and hydrazines, to name only a few.

The organolithium compounds prepared in this way can be reacted with any electrophilic compounds by methods of the prior art. For example, alkylations to produce ethers, thioethers, secondary and tertiary amines, etc., can be carried out by reaction with carbon electrophiles, or hemiacetals and their downstream produces and also esters, acid amides and carbonyl derivatives can be prepared by carbonyl additions.

The carbon electrophiles come, in particular, from one of the following categories (the product groups are in each case shown in brackets):
aryl or alkyl cyanates, isocyanates (carbonic acid derivatives)
oxirane, substituted oxiranes (2-hydroxy ethers, amines, thioethers, etc.)
aziridines, substituted aziridines (2-amino ethers, amines, thioethers, etc.)
imines, aldehydes, ketones (hemiacetals, hemiaminals, hemithioacetals, etc.)
organic halogen compounds, triflates, other sulfonates, sulfates (substitution products/alkylation products)
ketenes (carboxylic acid derivatives)
carboxylic acid chlorides (carboxylic acid derivatives)
carboxylic esters, thioesters and amides (carboxylic acid derivatives)
carbonic esters and phosgene derivatives (carboxylic acid derivatives)

As haloaliphatics or haloaromatics, it is possible to use all available or procurable fluorine, chlorine, bromine or iodine compounds, since lithium metal reacts readily with all haloaromatics and haloaliphatics in ether solvents, giving quantitative yields in virtually all cases. Preference is given here to using chloroaliphatics or bromoaliphatics, since iodo compounds are often expensive and fluorine compounds lead to the formation of LiF which can, as HF, lead to material problems in the later aqueous work-ups. In specific cases, however, such halides may also be able to be used advantageously.

In the process of the invention, preference is given to using alkyl or aryl halides which, after deprotonation, can be reacted to produce liquid alkanes or aromatics. Particular preference is given to using chlorocyclohexane or bromocyclohexane, benzyl chloride, tert-butyl chloride, chlorohexanes, chloroheptanes or chlorooctanes and also chlorobenzenes and bromobenzenes, chlorotoluenes and bromotoluenes and chloroxylenes and bromoxylenes.

The reaction is carried out in a suitable organic solvent, preferably an ether solvent such as tetrahydrofuran, dioxane, diethyl ether, di-n-butyl ether, glyme, diglyme, dibutyidiglyme or anisole. Particular preference is given to using tetrahydrofuran.

A further advantage of the process of the invention is that it can be carried out at quite high concentrations of organolithium compounds. Preference is given to concentrations of the aliphatic or aromatic intermediates of the formula (II) of from 5 to 30% by weight, in particular from 12 to 25% by weight.

In the preferred embodiment, halogen compound (R-Hal) and substrate to be deprotonated (III or IV) are added simultaneously or as a mixture to the lithium metal in the ether. In this one-pot variant, the organolithium compound is formed first and then immediately deprotonates the substrate. However, it is also possible (and especially appropriate when the substrate can undergo secondary reactions with metallic lithium firstly to generate the organolithium compound in ether by reaction of the halogen compound and lithium and only then add the substrate.

Owing to the high reactivity of the alkyllithium and aryllithium compounds, in particular toward, inter alia, the ethers used as solvents, the preferred reaction temperatures are in the range from −100 to +70° C.; particular preference is given to temperatures of from −80 to −25° C. if the deprotonation is not carried out simultaneously with the lithiation but in a second step. In the variant with simultaneous lithiation and deprotonation, the particularly preferred temperature range is from −40 to +40° C.

We have surprisingly found that in the preferred embodiment as a one-pot reaction, significantly higher yields and shorter reaction times than when RLi is generated first and the substrate to be deprotonated is only added subsequently are observed in many cases.

In the present process, the lithium can be used as dispersion, powder, turnings, sand, granules, pieces, bars or in another form, with the size of the lithium particles not being relevant to quality but merely influencing the reaction times. Preference is therefore given to relatively small particle sizes, for example granules, powders or dispersions. The amount of lithium added per mole of halogen to be reacted is from 1.95 to 2.5 mol, preferably from 1.98 to 2.15 mol.

In all cases, significant increases in the reaction rates can be observed when organic redox systems, for example biphenyl, 4,4′-di-tert-butyl-biphenyl or anthracene, are added. The addition of such systems has been found to be particularly advantageous when the lithiation times without this catalysis would be >12 hours.

Substrates which can be used for the deprotonation are firstly all oxygen, sulfur and nitrogen compounds which on the respective heteroatom bear a hydrogen atom which is sufficiently acidic to be deprotonated under the reaction conditions.

Mention may here be made, first and foremost, of all alcohols, thiols and nontertiary amines. The basisity of the organolithium compound formed is in virtually all cases sufficient to deprotonate these compounds. Compounds which are particularly easy to deprotonate are compounds (III) or (V) having groups R1 and R2 which are able to stabilize the resulting negative charge by mesomeric and/or inductive effects. This is the case for, for example, carboxyamides, arylamines, phenols, thiophenols, naphthols and also conjugated oximes, hydrazones, etc.

The lithium compounds generated according to the invention can be reacted with electrophilic carbon compounds (electrophiles) by methods with which those skilled in the art are familiar to give products having newly formed heteroatom-carbon bonds, which are of great interest for the pharmaceutical and agrochemicals industries.

The work-ups are generally aqueous, with either water or aqueous mineral acids being added or the reaction mixture being introduced into water or aqueous mineral acids. To achieve the best yields, the pH of the product to be isolated is in each case set. The reaction products are obtained, for example, by extraction and evaporation of the organic phases, or, as an alternative, the organic solvents can also be distilled off from the hydrolysis mixture and the product which then precipitates can be isolated by filtration.

The purities of the products from the process of the invention are generally high, but a further purification step, for example by recrystallization with addition of small amounts of activated carbon, may be necessary for special applications (pharmaceutical precursors). The yields of the reaction products are from 70 to 99%; typical yields are, in particular, from 85 to 95%.

The process of the invention provides a very economical method of bringing about the transformation of an aromatic hydrocarbon into any radicals in a highly selective, economical way.

The process of the invention is illustrated by the following examples, without the invention being restricted thereto.

### EXAMPLE 1

### Preparation of 2-furylmethyl propargyl ether from furylmethanol and propargyl bromide (two-step procedure)

A suspension of 1.45 g (0.210 mmol) lithium granules in 170 ml of tetrahydrofuran is cooled to −35° C. and slowly admixed with 13.29 g (0.105 mol) of 4-chlorotoluene. Stirring is continued at this temperature until the conversion of the 4-chlorotoluene is at least 97% a/a according to GC (about 8 hours). 9.81 g (0.100 mol) of 2-furylmethanol are added, the mixture is allowed to warm to room temperature, 14.28 g (0.120 mol) of propargyl bromide are added and the mixture is refluxed for 2 hours. After cooling, the reaction mixture is shaken with 100 ml of 2N hydrochloric acid and the phases are separated. The aqueous phase is reextracted twice with 50 ml each time of toluene, the combined organic phases are evaporated and the crude product is distilled under reduced pressure at up to 70° C. via a Vigreux column. This gives 12.66 g (0.093 mol, 93%) of 2-prop-2-yloxymethylfuran in an HPLC purity of >97% a/a.

### EXAMPLE 2

### Preparation of methyl N′-benzylidene-N-phenylhydrazinecarboxylate (acylation of benzaldehyde phenylhydrazone, one-pot variant)

A suspension of 1.45 g (0.210 mol) of lithium granules in 150 ml of tetrahydrofuran and 19.63 g (0.100 mol) of benzaldehyde phenylhydrazone is admixed at −40° C. with 15.61 g (0.105 mol) of octyl chloride and the mixture is stirred at −30° C. until the conversion of the octyl chloride according to GC is at least 97% a/a (about 8 hours). 11.34 g (0.120 mol) of methyl chloroformate are then added dropwise and the reaction mixture is stirred at 0° C. for 30 minutes. The reaction mixture is hydrolyzed with 100 ml of water, the phases are separated and the aqueous phase is extracted three times with 50 ml each time of toluene. The combined organic phases are evaporated and the crude product is recrystallized from ethanol. The product is obtained in the form of colorless, platelet-like crystals in a yield of 20.85 g (0.082 mol, 82%) and an HPLC purity of >98.5% ala.

### EXAMPLE 3

### Preparation of methyl N,N-diphenylcarbamate from diphenylamine (one-pot variant, catalyzed lithiation)

16.92 g (0.100 mol) of diphenylamine, 25 mg of biphenyl as redox catalyst and 1.45 g (0.105 mol) of lithium granules are added to 150 ml of tetrahydrofuran and the resulting suspension is cooled to −25° C. 13.29 g (0.105 mol) of 4-chlorotoluene are added dropwise over a period of 60 minutes. Stirring is continued until monitoring of the conversion by GC indicates a conversion of >97% a/a (about 4 hours), and 11.34 g (0.120 mol) of methyl chloroformate are then added dropwise to the reaction mixture. The reaction mixture is warmed to room temperature, the solvent and unreacted chloroformic ester are distilled off and the residue is fractionated via a short column. This gives 19.77 g (0.087 mol, 87%) of methyl N,N-diphenylcarbamate.

### EXAMPLE 4

### Preparation of dihexyl thioether from hexanethiol and bromohexane

1.45 g (0.105 mol) of lithium granules are suspended in a solution of 50 mg of biphenyl in 150 ml of tetrahydrofuran. At −30° C., 13.29 g (0.105 mol) of the technical-grade mixture of monochlorotoluene isomers are added dropwise and the reaction mixture is stirred at this temperature until the lithium granules have largely dissolved (about 6 hours). 11.82 g (0.100 mol) of hexanethiol are then added dropwise, the reaction mixture is warmed to 0° C., 16.51 g (0.100 mol) of bromohexane are added and the mixture is refluxed until monitoring of the conversion by GC indicates complete reaction. The cooled reaction mixture is extracted with 50 ml of water, the aqueous phase is reextracted with 50 ml of toluene and the combined organic phases are evaporated. The residue is distilled under reduced pressure. This gives 17.81 g (0.085 mol, 85%) of dihexyl thioether having a GC purity of >98%.

### EXAMPLE 5

### Preparation of benzyl N-benzyl-N-benzenesulfonylcarbamate from N-benzylbenzenesulfonamide

13.29 g (0.105 mol) of 4-chlorotoluene are added dropwise to a suspension of 1.45 g (0.210 mol) of lithium granules in 150 ml of tetrahydrofuran and 24.73 g (0.100 mol) of N-benzylbenzenesulfonamide at −40° C. and the mixture is stirred at this temperature until the conversion of the tolyl chloride according to GC is at least 97% a/a (about 6 hours). 11.34 g (0.120 mol) of benzyl chloroformate are then added dropwise and the reaction mixture is stirred overnight at room temperature. The reaction mixture is hydrolyzed with 100 ml of water, the phases are separated and the aqueous phase is reextracted with 100 ml of toluene. The combined organic phases are evaporated and the residue is purified by flash chromatography. This gives 26.30 g (0.069 mol, 69%) of the product having an HPLC purity of >96%

1. A process for forming heteroatom-carbon bonds, said process comprising reacting in a reaction mixture aliphatic or aromatic halogen compounds (I) with lithium metal to generate a lithium compound (II), deprotonating the compounds (III) or (V) by reaction with the lithium compound (II), and reacting the resulting lithium salts of the formula (IV) or (VI) with a suitable carbon electrophile to form the heteroatom-carbon bond and produce the product (VIII) or (VIII) (equation 1).
Step 1: Generation of the base 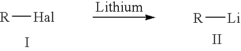
Step 2: Deprotonation of the substrate 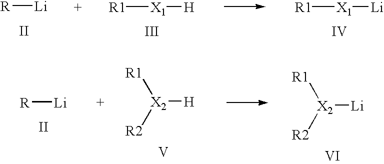
Step 3: Reaction with an electrophile 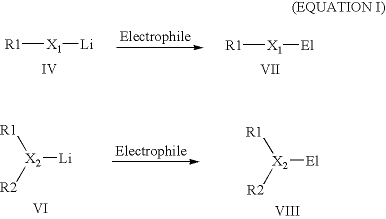
where, R is methyl, a primary, secondary or tertiary branched or unbranched alkyl radical having from 1 to 20 carbon atoms, a phenyl, aryl or heteroaryl radical, alkyl substituted by a radical selected from the group consisting of methyl, primary, secondary or tertiary alkyl, phenyl, substituted phenyl, aryl, heteroaryl, alkoxy, dialkylamino, alkylthio, substituted or unsubstituted cycloalkyl having from 3 to 8 carbon atoms, and mixtures thereof;
Hal is a halogen selected from the group consisting of fluorine, chlorine, bromine, iodine, and mixtures thereof,
X₁ is an oxygen or sulfur bound via a single bond to R1 or an sp2-hybridized nitrogen bound via a double bond to R1, and X₂ is an sp3-hybridized nitrogen;
the radicals R₁ and R₂ are independently of one another substituents selected from the group consisting of hydrogen, methyl, primary, secondary or tertiary, cyclic or acyclic alkyl, alkenyl or alkynyl radicals having from 1 to 20 carbon atoms, substituted cyclic or acyclic alkyl groups, acyl groups, alkoxy, aryloxy, dialkylamino, alkylamino, arylamino, diarylamino, alkylarylamino, imino, sulfone, sulfonyl, phenyl, substituted phenyl, alkylthio, diarylphosphino, dialkylphosphino, alkylarylphosphino, dialkylaminocarbonyl or diarylaminocarbonyl, monoalkylaminocarbonyl or monoarylaminocarbonyl, alkylarylaminocarbonyl, alkoxyalkyl, carboxylate, alkylcarboxylate, CN, CHO, heteroaryl and mixtures thereof, where two adjacent radicals R₁ and R₂ can together correspond to an aromatic or aliphatic ring.

2. The process as claimed in claim 1, wherein the compounds of the formula (III) are selected from the group consisting of alcohols, thiols, phenols, thiophenols, oximes, hydrazones, and mixtures thereof, and the compounds of the formula (V) are selected from the group consisting of amines, carboxamides, sulfonamides, hydrazines, and mixtures thereof.

3. The process of claim 1, wherein the electrophile is selected from the group consisting of aryl or alkyl cyanates, isocyanates, oxirane, substituted oxiranes, aziridines, substituted aciridines, imines, aldehydes, ketones, organic halogen compounds, triflates, other sulfonates, sulfates, ketenes, carboxylic acid chlorides, carboxylic esters, thioesters and amides, carbonic esters, phosgene derivatives, and mixtures thereof.

4. The process of claim 1, wherein the reaction is carried out in an organic ether solvent.

5. The process of claim 1, wherein said reacting step is carried out at a reaction temperature in the range from −100 to +70° C.

6. The process of claim 1, wherein a concentration of aliphatic or aromatic intermediates of the formula (II) are in the range from 5 to 30% by weight.

7. The process of claim 1, wherein lithium metal is added in an amount per mole of halogen reacted ranging from 1.95 to 2.5 mol.

8. The process of claim 1, further comprising adding organic redox systems to the reaction mixture.
